(19) United States
(12) Patent Application Publication
(10) Pub. No.: US 2021/0260746 A1
(43) Pub. Date: Aug. 26, 2021

(54) Socket Holder Tool Attachment Apparatus

(71) Applicant: Joshua Anderson, Galt, CA (US)

(72) Inventor: Joshua Anderson, Galt, CA (US)

(21) Appl. No.: 16/802,224

(22) Filed: Feb. 26, 2020

(51) Int. Cl. B25H 3/04

(52) U.S. Cl. CPC B25H 3/04

(57) ABSTRACT

A socket holder tool attachment apparatus for securing sockets to tools includes a rail having a rail top side, a rail bottom side, a rail front end, and a rail back end. A front clip is coupled to the rail bottom side proximal the rail front end and a back clip is coupled to the rail bottom side proximal the rail back end. Each of the front clip and the back clip is configured to attach to a tool. A plurality of socket posts is coupled to the rail top side. The plurality of socket posts is configured to selectively receive a plurality of sockets.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tool attachments and more particularly pertains to a new tool attachment for securing sockets to tools.

### (2) Description of Related Art Including Information Disclosed Under 37 CFR 1.97 and 1.98

The prior art relates to tool attachments for keeping sockets. Existing devices typically employ a type of strap that must be wrapped around the tool and are thus limited to which tools may be attached to. They also inherently place some sockets in less convenient locations than others on the tool. Socket organizers typically arrange sockets in a linear array of increasing size so the correct socket may be easily located and replaced. Existing devices fail to employ this organizational arrangement while also offering easy attachment to a variety of different tools.

### BRIEF SUMMARY OF THE INVENTION

An embodiment of the disclosure meets the needs presented above by generally comprising a rail having a rail top side, a rail bottom side, a rail front end, and a rail back end. A front clip is coupled to the rail bottom side proximal the rail front end and a back clip is coupled to the rail bottom side proximal the rail back end. Each of the front clip and the back clip is configured to attach to a tool. A plurality of socket posts is coupled to the rail top side. The plurality of socket posts is configured to selectively receive a plurality of sockets.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a socket holder tool attachment apparatus according to an embodiment of the disclosure.

FIG. 2 is a side elevation view of an embodiment of the disclosure.

FIG. 3 is a rear elevation view of an embodiment of the disclosure.

FIG. 4 is an in-use view of an embodiment of the disclosure.

FIG. 5 is an in-use view of an embodiment of the disclosure.

### DETAILED DESCRIPTION OF THE INVENTION

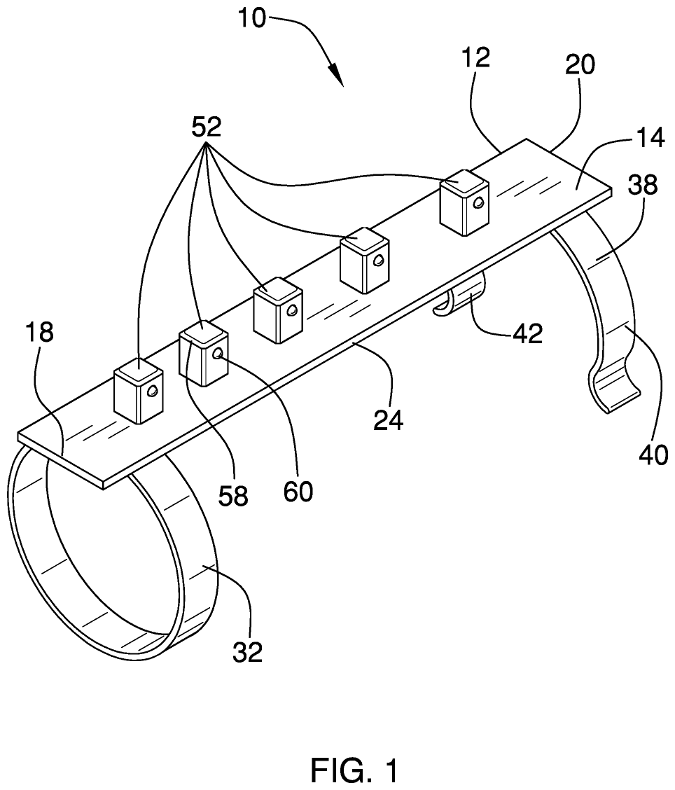

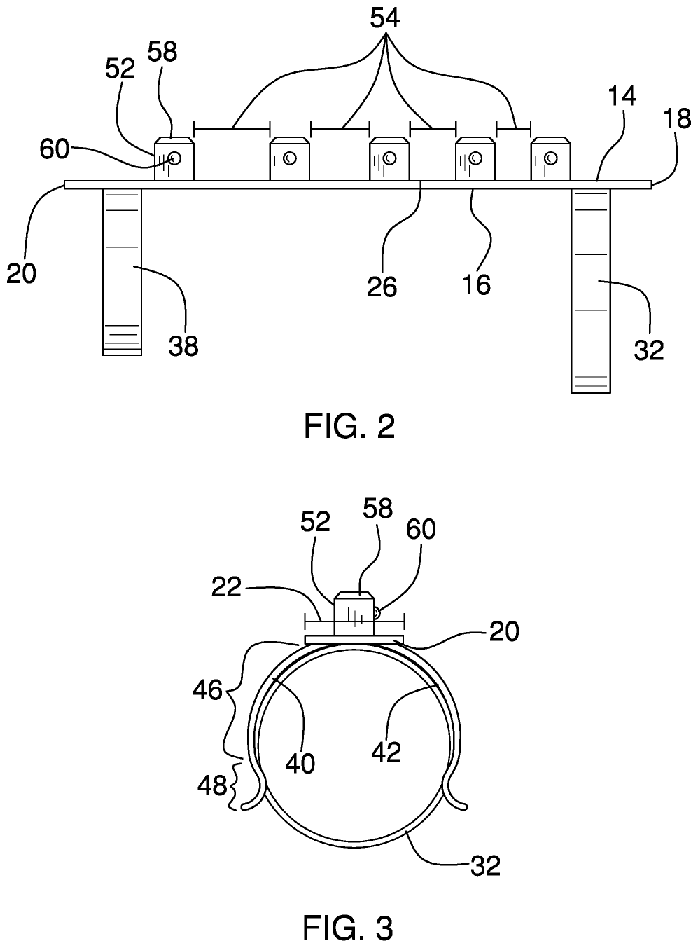

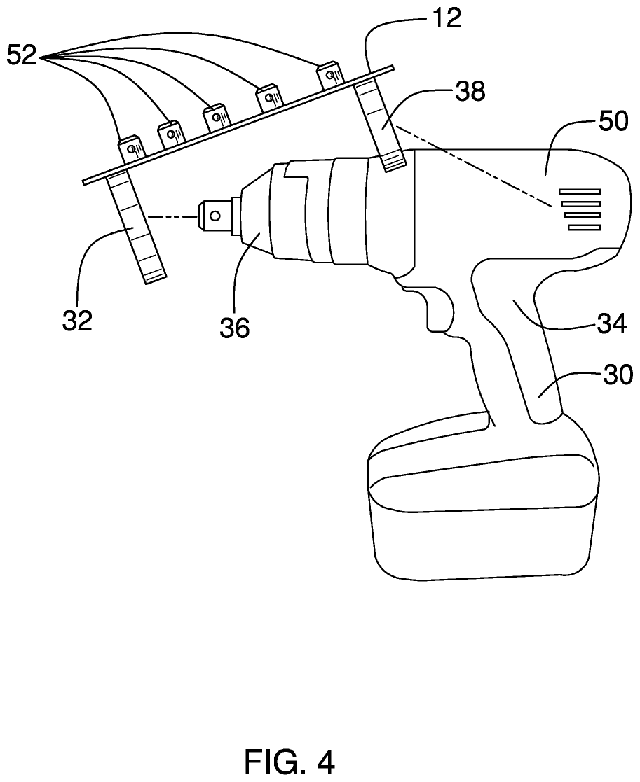

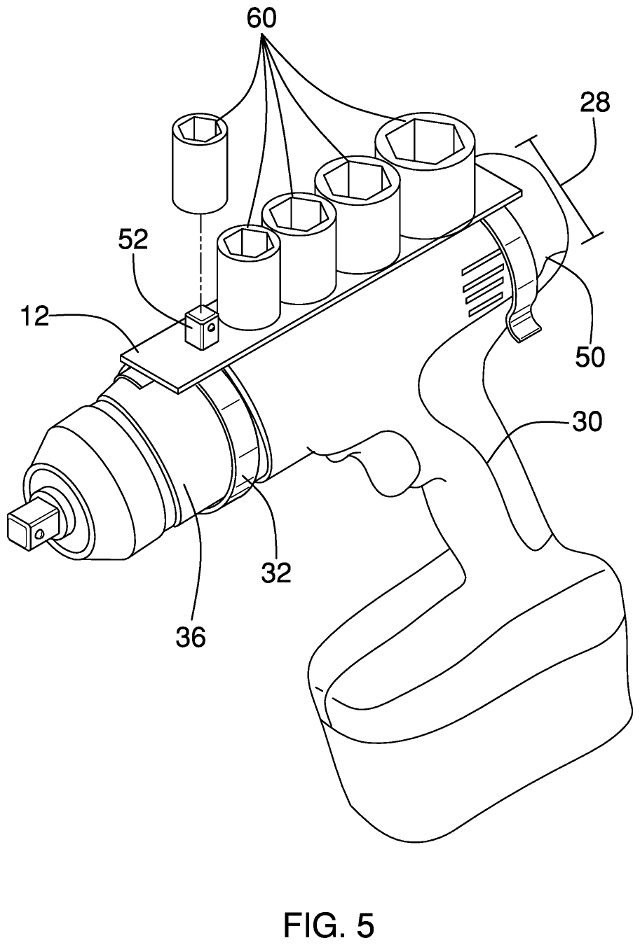

With reference now to the drawings, and in particular to FIGS. 1 through 5 thereof, a new tool attachment embodying the principles and concepts of an embodiment of the disclosure and generally designated by the reference numeral 10 will be described.

As best illustrated in FIGS. 1 through 5, the socket holder tool attachment apparatus 10 generally comprises a rail 12 having a rail top side 14, a rail bottom side 16, a rail front end 18, and a rail back end 20. The rail 12 may be rectangular and semi-rigid. A rail width 22 between a rail left edge 24 and a rail right edge 26 is configured to be less than a tool width 28 of a tool 30. A front clip 32 is coupled to the rail bottom side 16 proximal the rail front end 18. The front clip 32 may be annular and configured to selectively engage a handheld drill 34 proximal a drill chuck 36 thereof.

A back clip 38 is coupled to the rail bottom side 16 proximal the rail back end 20. The back 38 comprises a left arm 40 and a right arm 42 defining a receiving area 44 therebetween. Each of the left arm 40 and the right arm 42 may have an arched portion 46 and a convexly curved distal portion 48. The receiving area 44 is configured to receive a drill body 50 of the handheld drill. The arched portion 46 may complete at least a 90° arc to secure the apparatus 10 to the drill body 50. The curved distal portions 48 allow the left arm 40 and the right arm 42 to spread when pressed against the drill body 50. The back clip 48 is elastic such that the left arm 40 and the right arm 42 are biased to return to their rest position and thus squeeze the drill body 50. The curved distal portions 48 additionally provide an area for the user to easily grip and manually spread the left arm 40 and the right arm 42 for easy removal.

In another embodiment of the invention the front clip 32 is the same as the back clip 38 with the receiving area 44 of each dimensioned and configured to attach to a socket driver.

A plurality of socket posts 52 is coupled to the rail top side 14. The plurality of socket posts 52 may be arranged in a linear array with a distance 54 between each pair of adjacent socket posts 52 of the plurality of socket posts progressively increasing. The plurality of socket posts 52 is configured to selectively receive a plurality of sockets 56. The variable distance 54 between each pair of adjacent socket posts 52 allows for a range of different sized sockets 56 to be attached. Each socket post 52 may be rectangular prismatic and may have a chamfered top edge 58. Each socket post 52 is configured to conform to standard socket driver dimensions including ¼″, ⅜″, and ½″. Each socket post 52 may have a spring-loaded ball protrusion 60 to engage the respective socket 56 and prevent it from separating from the socket post 52 until pulled by the user.

In use, the front clip 32 and the back clip 38 are engaged on the tool 30. The plurality of sockets 56 to be used is selected and attached to the plurality of socket posts 52. As a socket is needed, it is removed from the respective socket post 52, attached to the tool 30, used, and then replaced.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A socket holder tool attachment apparatus comprising:
a rail having a rail top side, a rail bottom side, a rail front end, and a rail back end;
a front clip coupled to the rail bottom side proximal the rail front end;
a back clip coupled to the rail bottom side proximal the rail back end, each of the front clip and the back clip being configured to attach to a tool; and
a plurality of socket posts coupled to the rail top side, the plurality of socket posts being configured to selectively receive a plurality of sockets.

2. The socket holder tool attachment apparatus of claim 1 further comprising the front clip being annular and configured to selectively engage a handheld drill proximal a drill chuck thereof.

3. The socket holder tool attachment apparatus of claim 2 further comprising the back clip comprising a left arm and a right arm defining a receiving area therebetween, the receiving area being configured to receive a drill body of the handheld drill.

4. The socket holder tool attachment apparatus of claim 3 further comprising each of the left arm and the right arm having an arched portion and a convexly curved distal portion.

5. The socket holder tool attachment apparatus of claim 4 further comprising the arched portion completing at least a 90° arc.

6. The socket holder tool attachment apparatus of claim 1 further comprising the plurality of socket posts being arranged in a linear array with a distance between each pair of adjacent socket posts of the plurality of socket posts progressively increasing.

7. The socket holder tool attachment apparatus of claim 1 further comprising each socket post being rectangular prismatic and being configured to conform to standard socket driver dimensions including ¼″, ⅜″, and ½″.

8. The socket holder tool attachment apparatus of claim 7 further comprising each socket post having a chamfered top edge.

9. The socket holder tool attachment apparatus of claim further comprising each socket post having a spring-loaded ball protrusion.

10. A socket holder tool attachment apparatus comprising:
a rail having a rail top side, a rail bottom side, a rail front end, and a rail back end;
a front clip coupled to the rail bottom side proximal the rail front end, the front clip being annular and configured to selectively engage a handheld drill proximal a drill chuck thereof;
a back clip coupled to the rail bottom side proximal the rail back end, the back clip comprising a left arm and a right arm defining a receiving area therebetween, each of the left arm and the right arm having an arched portion and a convexly curved distal portion, the arched portion completing at least a 90° arc, the receiving area being configured to receive a drill body of the handheld drill; and
a plurality of socket posts coupled to the rail top side, the plurality of socket posts being arranged in a linear array with a distance between each pair of adjacent socket posts of the plurality of socket posts progressively increasing, the plurality of socket posts being configured to selectively receive a plurality of sockets, each socket post being rectangular prismatic and having a chamfered top edge, each socket post being configured to conform to standard socket driver dimensions including ¼″, ⅜″, and ½″, each socket post having a spring-loaded ball protrusion.
